(19) United States
(12) Patent Application Publication
(10) Pub. No.: US 2009/0122406 A1
(43) Pub. Date: May 14, 2009

(54) Optical Image Stabilizer Using Gimballed Prism

(76) Inventors: Jarkko Rouvinen, Espoo (FI); Petteri Kauhanen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/223,506

(22) PCT Filed: Feb. 6, 2006
(86) PCT No.: PCT/IB2006/000219

§ 371 Date: Oct. 31, 2008

(51) Int. Cl. G02B 27/64

(52) U.S. Cl. 359/555

(57) ABSTRACT

An optical image stabilizer is used to compensate for an unwanted movement of an imaging system, such as a camera. The camera has a folded optics system using a triangular prism to fold the optical axis. Two actuators are used to rotate the prism around two axes in order to compensate for the yaw motion and pitch motion of the camera. The prism can be mounted on a gimballed system or joint and two actuators are operatively connected to the gimballed system in order to rotate the prism. Alternatively, the folded optics system uses a mirror to fold the optical axis, and two motors are used to rotate the prism.

### FIELD OF THE INVENTION

The present invention relates generally to an imaging system and, more particularly, to an optical image stabilizer for use in an imaging system.

### BACKGROUND OF THE INVENTION

The problem of image stabilization dates back to the beginning of photography, and the problem is related to the fact that an image sensor needs a sufficient exposure time to form a reasonably good image. Any motion of the camera during the exposure time causes a shift of the image projected on the image sensor, resulting in a degradation of the formed image. The motion related degradation is called motion blur. Using one or both hands to hold a camera while taking a picture, it is almost impossible to avoid an unwanted camera motion during a reasonably long exposure time. Motion blur is particularly easy to occur when the camera is set at a high zoom ratio when even a small motion could significantly degrade the quality of the acquired image.

Optical image stabilization generally involves laterally shifting the image projected on the image sensor in compensation for the camera motion. Shifting of the image can be achieved by one of the following four general techniques:

Lens shift—this optical image stabilization method involves moving one or more lens elements of the optical system in a direction substantially perpendicular to the optical axis of the system;

Image sensor shift—this optical image stabilization method involves moving the image sensor in a direction substantially perpendicular to the optical axis of the optical system;

Liquid prism—this method involves changing a layer of liquid sealed between two parallel plates into a wedge in order to change the optical axis of the system by refraction; and

Camera module tilt—this method keeps all the components in the optical system unchanged while tilting the entire module so as to shift the optical axis in relation to a scene.

In any one of the above-mentioned image stabilization techniques, an actuator mechanism is required to effect the change in the optical axis or the shift of the image sensor. Actuator mechanisms are generally complex, which means that they are expensive and large in size.

It is thus desirable to provide a cost-effective method and system for optical image stabilization where the stabilization can be small in size.

### SUMMARY OF THE INVENTION

The present invention uses an optical image stabilizer to compensate for an unwanted movement of an imaging system, such as a camera. The camera, according to the present invention, has a folded optics system using a triangular prism to fold the optical axis. Two actuators are used to rotate the prism around two axes in order to compensate for the yaw motion and pitch motion of the camera. The prism can be mounted on a gimballed system or joint and two actuators are operatively connected to the gimballed system in order to rotate the prism.

Thus, the first aspect of the present invention is an imaging system. The imaging system comprises:

an image forming medium located on an image plane;

a lens module for projecting an image on the image forming medium, the lens module defining an optical axis;

an optical path folding device disposed in relationship to the lens module for folding the optical axis; and

a movement mechanism operatively connected to the optical path folding device for moving the optical path folding device in order to shift the image on the image forming medium in response to an unwanted movement of the imaging system.

The image forming medium comprises an image sensor located substantially on the image plane of the imaging system. The optical path folding device can be a prism or a reflection surface, such as a mirror. The optical path folding device is rotatable by actuators or motors about a first rotation axis substantially perpendicular to the image plane, and about a second rotation axis substantially parallel to the image plane and the reflection surface of the optical path folding device.

The second aspect of the present invention is an optical image stabilizer module for use in an imaging system having an image sensor located in an image plane, at least one lens element to project an image on the image sensor, the lens element defines an optical axis, and a reflection surface disposed in relationship to the lens element for folding the optical axis. The image stabilizer module comprises:

a movement mechanism, operatively connected to the reflection surface, for moving the reflection surface in order to shift the image on the image sensor in response to an unwanted movement of the imaging system. The movement mechanism may comprise two actuators to be activated by a driving system. The movement mechanism may comprise two motors instead.

The optical image stabilizer may further comprises:

a driving system for activating the movement device in response to the unwanted movement of the imaging system;

a position sensing device for sensing a current position of the prism; and

a processing module, operatively connected to the position sensing device and the movement detector, for determining the moving amount of the prism based on the unwanted movement of the imaging system and the current position of the prism, so as to allow the movement device to move the prism in order to compensate for the unwanted movement of the imaging system.

The third aspect of the present invention is an image shifting method for use in an imaging system in order to compensate for an unwanted movement of the imaging system. The imaging system has a reflection surface disposed in relationship to the lens element for folding the optical axis. The method comprises the steps of:

rotating the reflection surface about a first rotation axis, the first rotation axis substantially perpendicular to the image plane, and

rotating the reflection about a second rotation axis, the second rotation axis substantially parallel to the image plane and the reflection surface so as to shift the projected image on the image sensor.

The present invention will become apparent upon reading the description taken in conjunction with FIGS. 1 to 11.

### BRIEF DESCRIPTION OF THE DRAWINGS

FIG. 1 is a schematic representation of a camera phone having folded optics.

FIG. 2 is a schematic representation of the imaging system having a plurality of lens elements, an image sensor and a prism for folding the optical axis of the imaging system.

FIG. 3 shows the prism with two rotation axes related to the yaw and pitch of the imaging system.

FIGS. 4a-4c show how the prism is rotated to correct for the motion blur due to the pitch motion of the imaging system.

FIG. 5a shows one way for using a bending actuator to rotate the prism around the Y-axis.

FIG. 5b shows another way for using a bending actuator to rotate the prism around the Y-axis.

FIG. 5c shows a way for using an on-axis actuator to rotate the prism around the Y-axis.

FIG. 5d shows a movement mechanism being used to rotate the prism around the Y-axis.

FIG. 6a shows a top view of the prism.

FIG. 6b shows one way for using a bending actuator to rotate the prism around the Z-axis.

FIG. 6c shows another way for using a bending actuator to rotate the prism around the Z-axis.

FIG. 6d shows one way for using an on-axis actuator to rotate the prism around the Z-axis.

FIG. 6e shows a movement mechanism being used to rotate the prism around the Z-axis.

FIG. 7a shows a side view of the folded optics having a gimballed prism for optical image stabilization, according to the present invention.

FIG. 7b shows the details of the gimballed prism.

FIG. 7c shows part of the imaging system having a slot for fixedly mounting a bending actuator.

FIG. 8 shows a front view of gimballed joint and prism.

FIG. 9a shows an exemplary embodiment of the gimballed joint having two bending actuators for causing the gimballed joint to rotate around two axes.

FIG. 9b shows another view of the gimballed joint.

FIG. 10 shows a typical driving system for driving an actuator.

FIG. 11 shows a typical optical image stabilizing system.

### DETAILED DESCRIPTION OF THE INVENTION

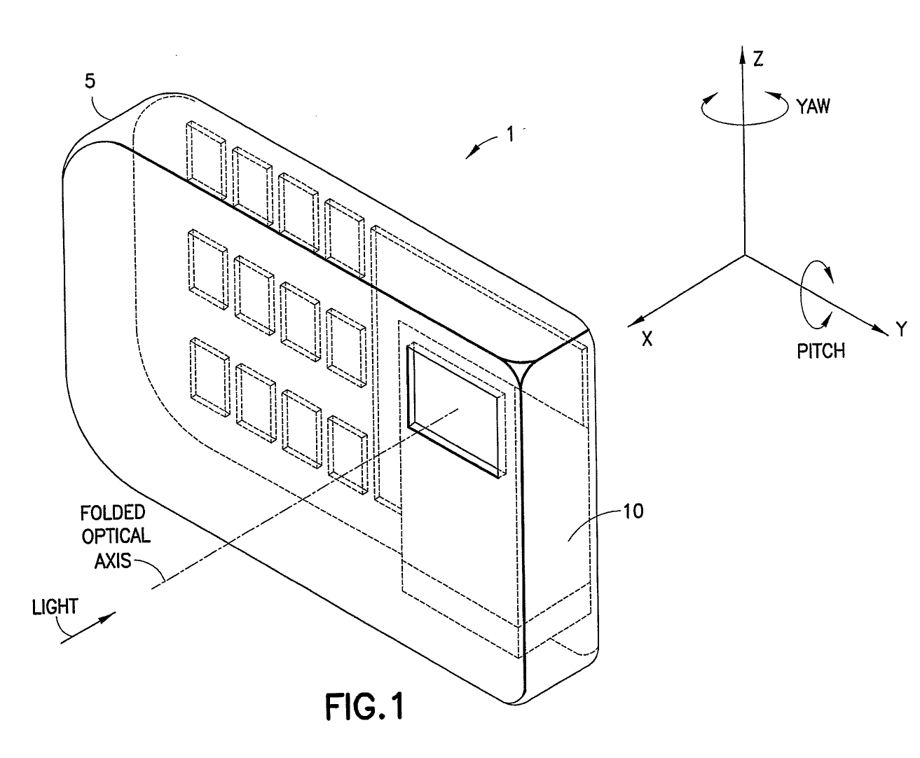

In an imaging system having an image sensor and a lens to project an image on the image sensor along an optical axis, the present invention uses a triangular prism to fold the optical axis. An imaging system with folded optics is particularly useful to be implemented in a thin electronic device, such as a mobile phone. FIG. 1 is a schematic representation of a camera phone having folded optics.

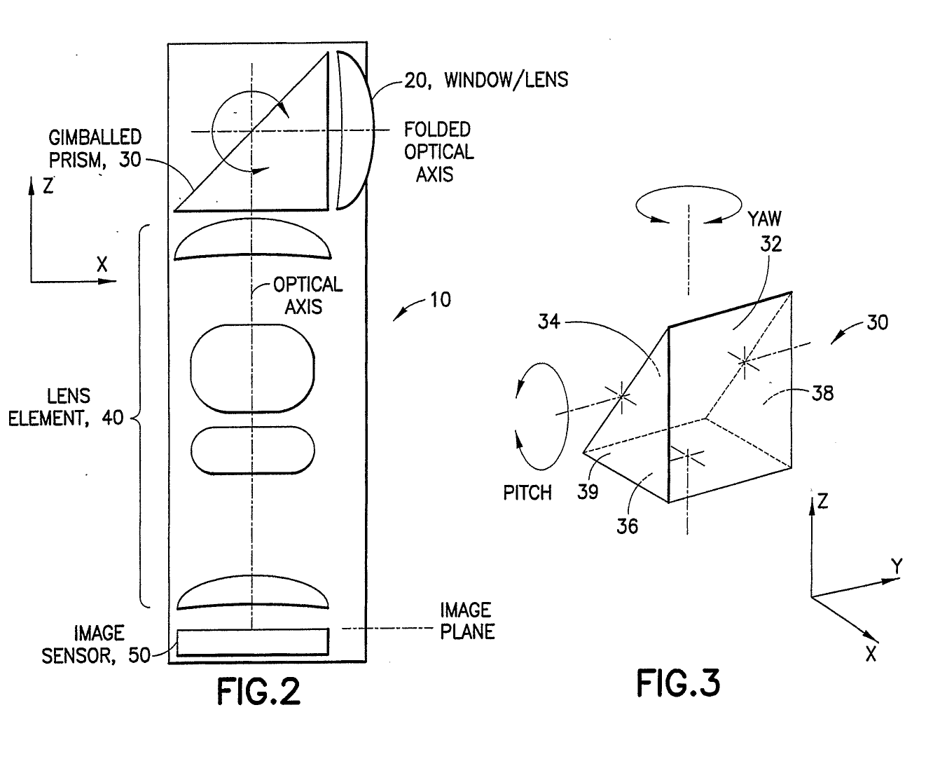

As shown in FIG. 1, the mobile phone 1 has a camera or imaging system 10 so as to allow a user to take pictures using the imaging system. As shown in FIGS. 1 and 2, the optical axis of the imaging system 10, which is substantially parallel to the Z-axis, is folded such that the folded optical axis is substantially parallel to the X-axis. As shown in FIG. 2, the imaging system 10 comprises an image sensor 50 located on an image plane, a front lens or window 20, a triangular prism 30 and possibly a plurality of other lens elements 40. When a user uses a camera phone such as the mobile phone 1 to take pictures, the user's hand may involuntarily shake, causing the mobile phone to rotate around the Y-axis in a pitch motion, and to rotate around the Z-axis in a yaw motion. These motions may introduce a motion blur to an image being exposed on the image sensor 50.

In order to compensate for the pitch and yaw motions during the exposure time, an optical image stabilizer is used. The optical image stabilizer, according to the present invention, comprises two actuators for causing the prism to rotate around two axes. The rotation axes of the prism are shown in FIG. 3. As shown in FIG. 3, the prism 30 has two triangular faces 38, 39 substantially parallel to the Z-X plane, a base 36 substantially parallel to the X-Y plane, a front face 32 substantially parallel to the Y-Z plane and a back face 34 making a 45 degree angle to the base 36. In order to reduce the motion blur, the prism may be caused to rotate around the Z-axis and the Y-axis.

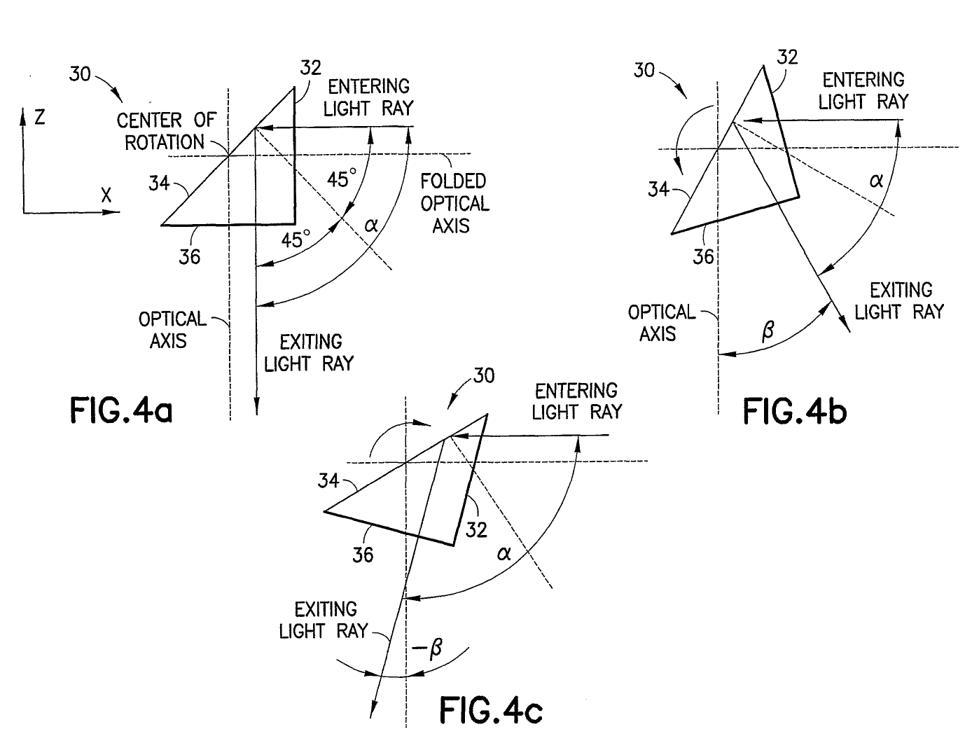

As known in the art, when light enters the prism from its front face 32 in a direction parallel to the X-axis, the light beam is reflected by total internal reflection (TIR) at the back face 34. FIG. 4a shows the prism 30 in its normal position. As the light beam encounters the back face 34 at a 45 incident angle, it is reflected toward the image sensor along a direction substantially along the Z-axis, or the optical axis of the imaging system. When the prism 30 is effectively rotated around the Y-axis in a counter-clockwise direction as shown in FIG. 4b, the reflected light beam is caused to rotate by a positive angle β. When the prism 30 is caused to rotate around the Y-axis in a clockwise direction as shown in FIG. 4c, the reflected light beam is effectively rotated by a negative angle —β. Thus, the tilting of the prism around the Y-axis can be used to compensate for the unwanted pitch motion on the imaging system.

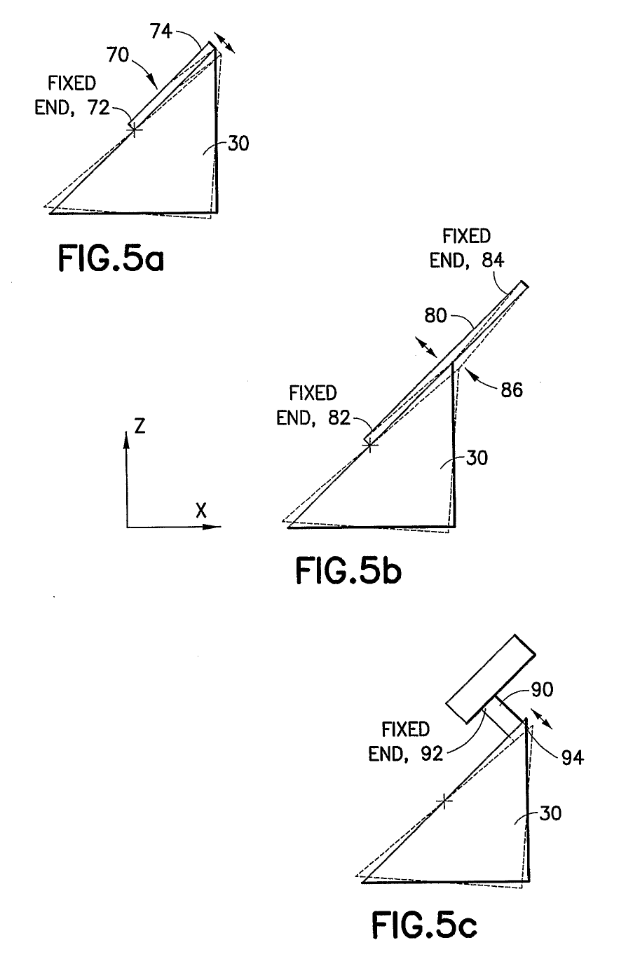

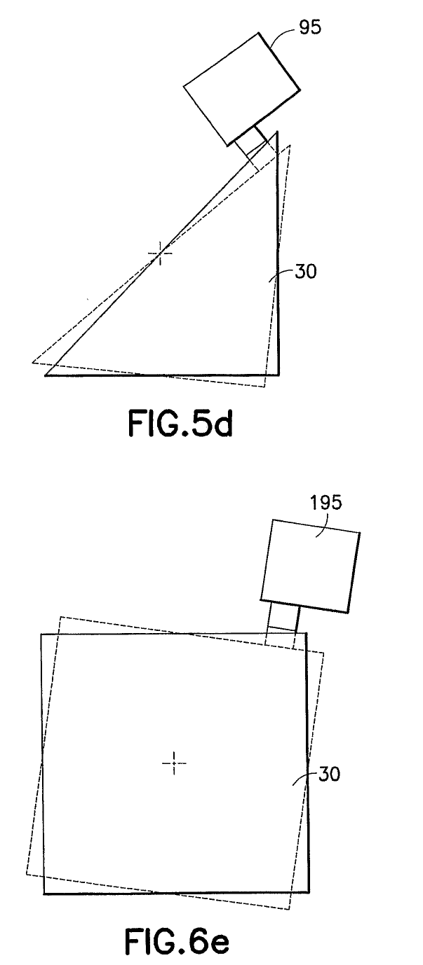

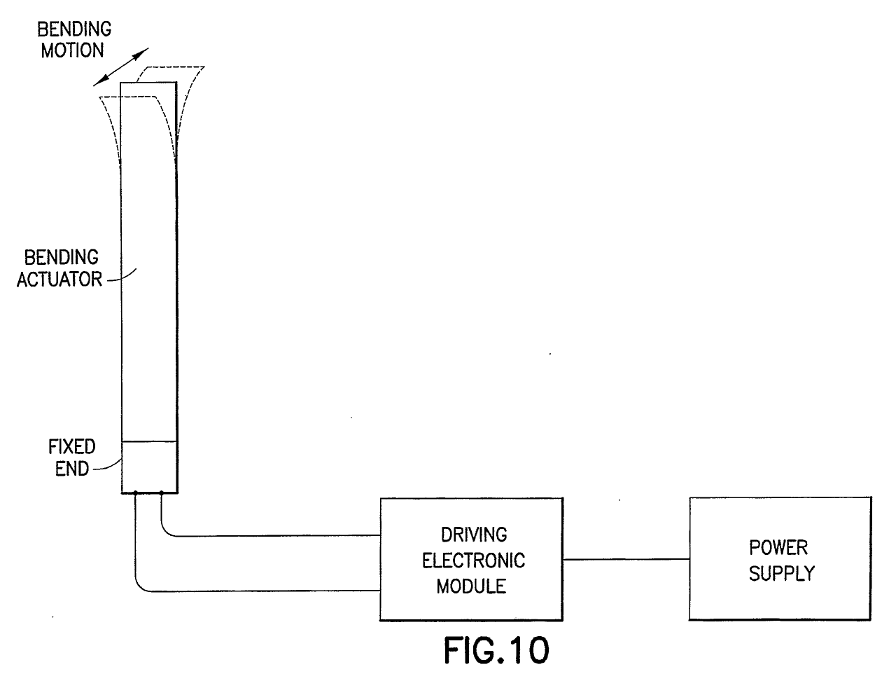

The tilting of the prism can be achieved by using an actuator operatively connected to a driving electronic module, which activates the actuator upon receiving a signal from a motion sensing device (see FIG. 10). FIGS. 5a to 5c show a few examples of how an actuator is used to rotate the prism around the Y-axis for pitch motion compensation. FIG. 5a shows a bending actuator 70 being used to rotate the prism 30 around the Y-axis. As shown, one end 72 of the bending actuator 70 is fixedly mounted on the imaging system and the other end 74 is operatively connected to the prism 30. Upon activation, the bending motion of the end 74 causes the prism 30 to tilt. FIG. 5b shows a bending actuator 80 being used to rotate the prism 30 around the Y-axis. As shown, both ends 82, 84 of the bending actuator 80 are fixedly mounted on the image system and the middle section 86 of the bending actuator 80 is operatively connected to the prism 30. Upon activation, the bending motion of the middle section 86 causes the prism 30 to tilt. It should be noted that it is also possible to fixedly mount a middle section of the bending actuator 80 and operatively connect one or both ends of the bending actuator 80 to the prism to cause the prism 30 to tilt.

FIG. 5c shows an on-axis actuator 90 being used to rotate the prism around the Y-axis. As shown, one end 92 of the actuator 90 is fixedly mounted on imaging system and the other end 94 is operatively connected to the prism 30. Upon activation, the contraction or expansion of the actuator 90 causes the prism 30 to tilt.

FIG. 5d shows that a movement device 95 such as an electromagnetic stepping motor, an ultrasonic piezoelectric motor or the like being used to cause the prism 30 to rotate the prism around the Y-axis.

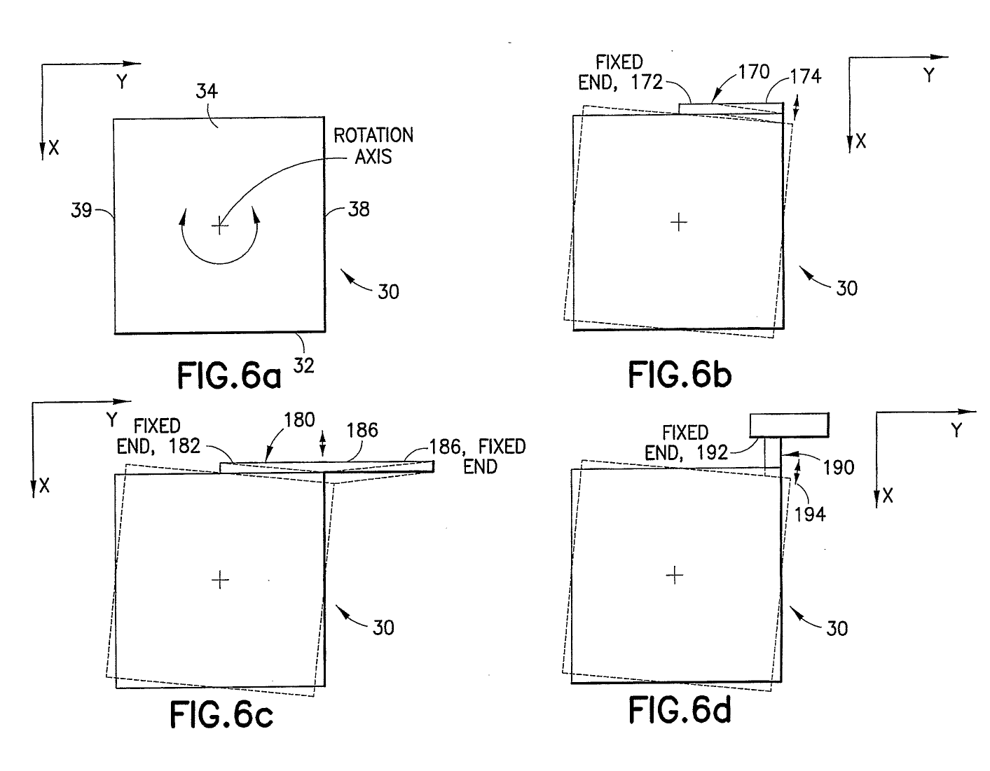

The rotation of the prism 30 around the Z-axis for yaw motion compensation can also be achieved by an actuator. FIG. 6a is a top view of the prism 30, showing the rotation axis in relation to various faces of the prism 30. FIGS. 6b to 6d show a few examples of how an actuator is used to rotate the prism around the Z-axis for yaw motion compensation. FIG. 6b shows a bending actuator 170 being used to rotate the prism 30 around the Z-axis. As shown, one end 172 of the bending actuator 170 is fixedly mounted on the imaging system and the other end 174 is operatively connected to the prism 30. Upon activation, the bending motion of the end 174 causes the prism 30 to turn. FIG. 6c shows a bending actuator 180 being used to rotate the prism 30 around the Z-axis. As shown, both ends 182, 184 of the bending actuator 180 are fixedly mounted on the image system and the middle section 186 of the bending actuator 180 is operatively connected to the prism 30. Upon activation, the bending motion of the middle section 186 causes the prism 30 to turn. It should be noted that it is also possible to fixedly mount a middle section of the bending actuator 180 and operatively connect one or both ends of the bending actuator 180 to the prism to cause the prism 30 to tilt.

FIG. 6d shows an on-axis actuator 190 being used to rotate the prism around the rotation axis. As shown, one end 192 of the actuator 190 is fixedly mounted on imaging system and the other end 194 is operatively connected to the prism 30. Upon activation, the contraction or expansion of the actuator 190 causes the prism 30 to turn.

FIG. 6e shows that a movement device 195 such as an electromagnetic stepping motor, an ultrasonic piezoelectric motor or the like being used to cause the prism 30 to rotate the prism around the Z-axis.

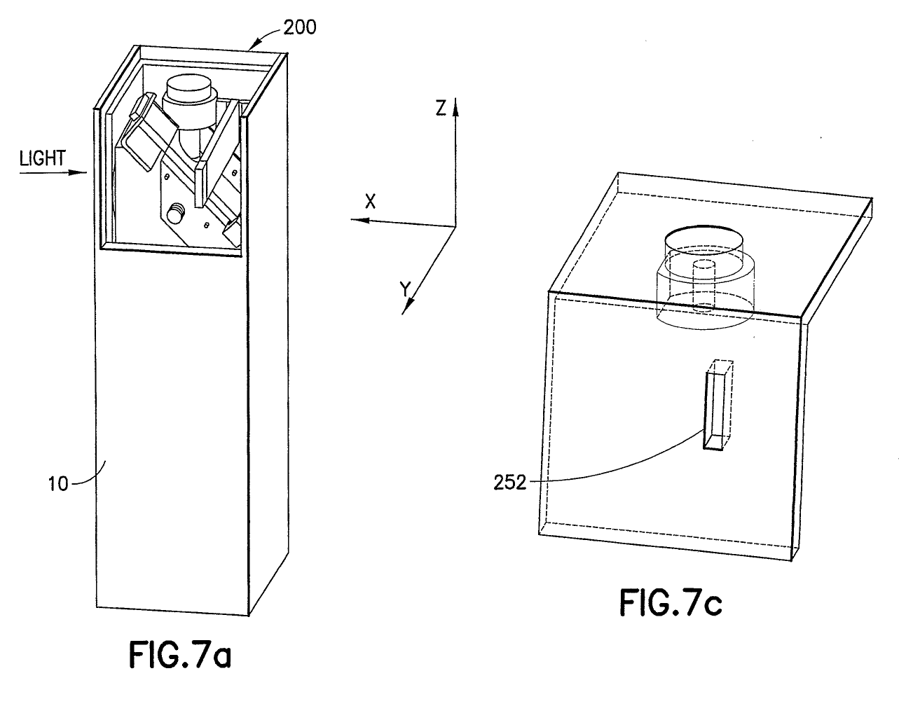

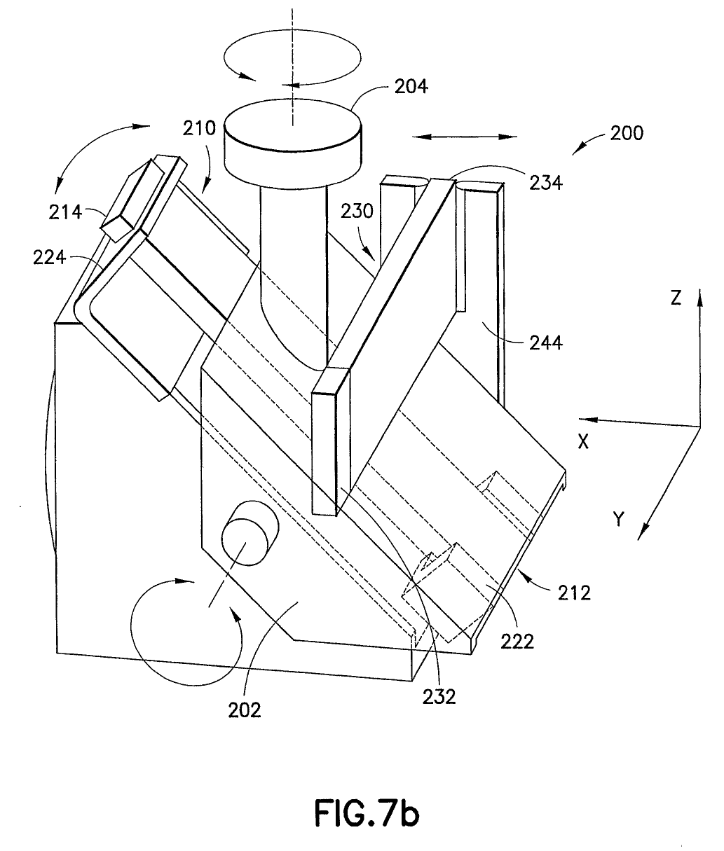

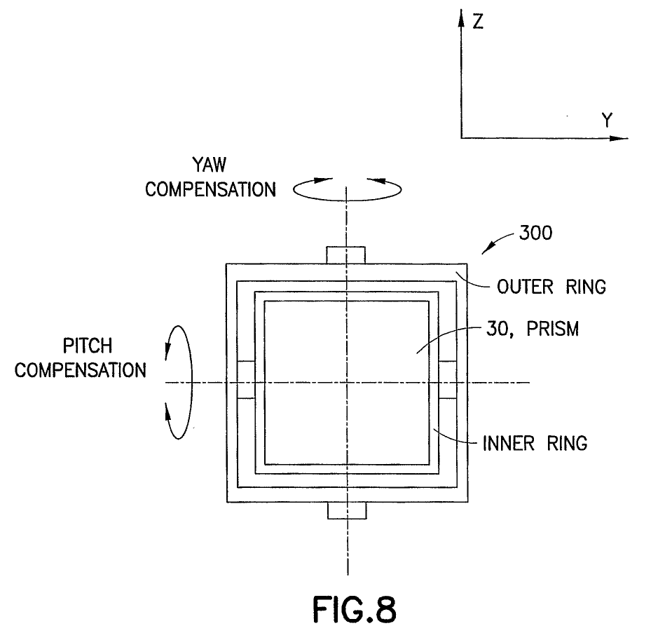

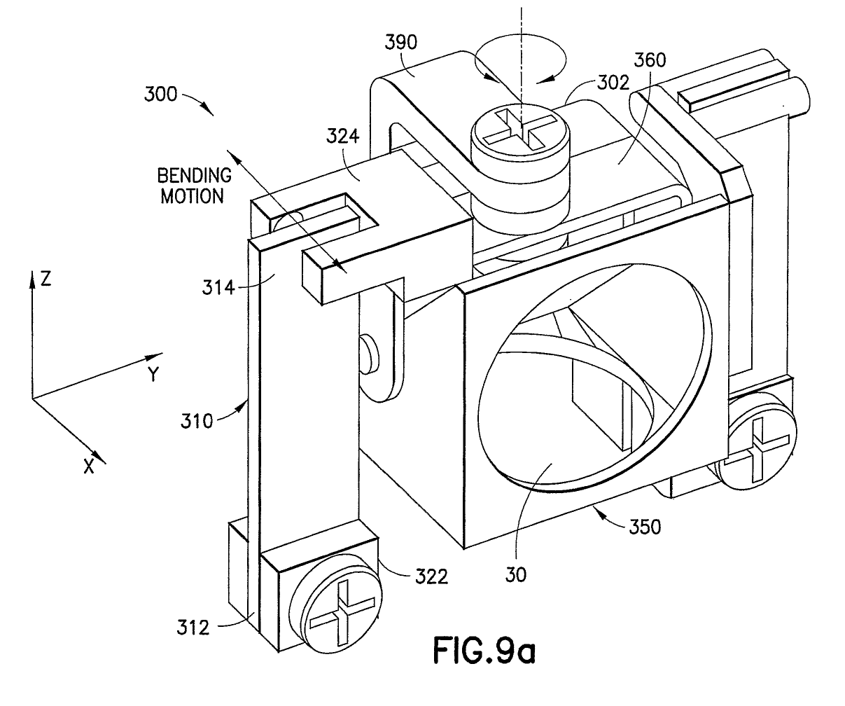

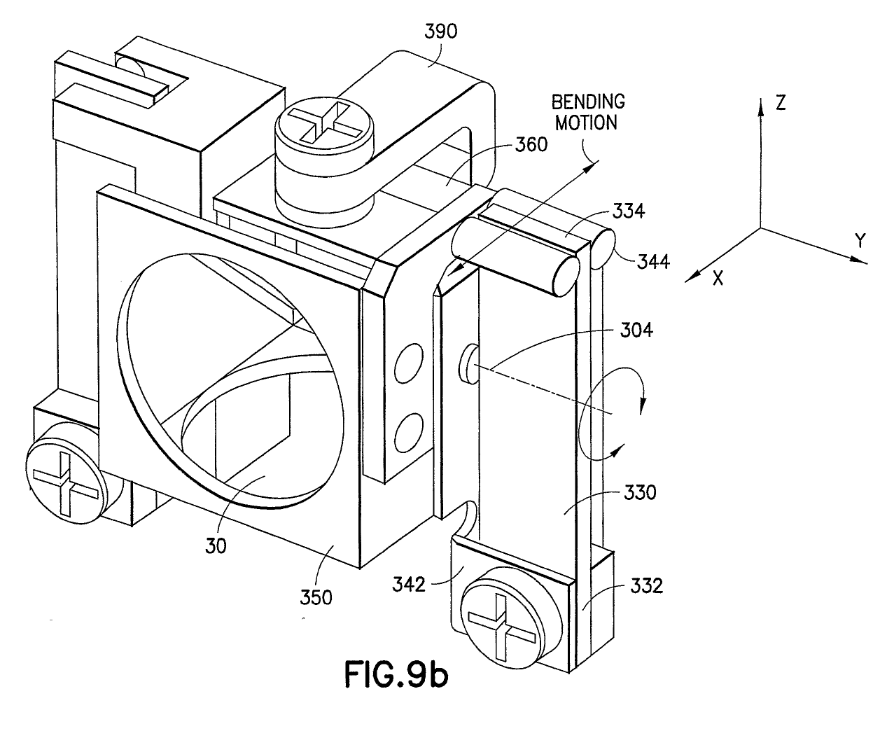

The turning and tilting of the prism 30 in the imaging system can be achieved by using two bending actuators in a gimballed system as shown in FIG. 7a-7c, or in a gimballed joint as shown in FIGS. 8-9b, for example.

FIGS. 7a-7c illustrate how two bending actuators are used for rotating the prism around the Z and Y-axes in the imaging system 10. FIG. 7a shows a side view of the folded optics having a gimballed prism system 200 for optical image stabilization, according to the present invention. The prism 30 is hidden inside the gimballed system 200. FIG. 7b shows the details of the gimballed prism system 200. As shown in FIG. 7b, the gimballed prism system 200 is mounted on the imaging system at a first pivot 202 for Y-axis rotation and at a second pivot 204 for Z-axis rotation. The gimballed prism system 200 has a first bending actuator 210 for tilting the prism (not shown) around the Y-axis and a second bending actuator 230 for turning the prism around the Z-axis. As shown, a bracket 222 is used to mount the fixed end 212 of the bending actuator 210. Another bracket 224 is operatively connected to other end 214 of the bending actuator 210. The bracket 224 is linked to the prism system 200 such that the bending motion on the actuator end 214 causes the prism to rotate around the pivot 202 through the bracket 224. As shown in FIG. 7c, part of the housing of the imaging system 10 has a slot 252 for fixedly mounting the fixed end 232 of the bending actuator 230. The movable end 234 of the bending actuator is operatively connected to a bracket 244, which is linked to the prism system 200 such that the bending motion on the actuator end 234 causes the prism to rotate around the pivot 204.

FIG. 8 shows the mechanism of a gimballed joint 300. The gimballed joint is also known as a cardanic suspension. As shown in FIG. 8, the gimballed joint 300 has an outer ring and an inner ring and two pairs of joints on two crossed axes. When a prism 30 is fixedly mounted on the inner ring, it can be caused to move in different directions for yaw and pitch compensation.

FIGS. 9a and 9b show an exemplary embodiment of the gimballed joint having two bending actuators for causing the gimballed joint to rotate around two axes. As shown in FIGS. 9a and 9b, the cardanic suspension is movably mounted on a bracket 390 at a pivot 302 so that the outer ring 360 of the gimballed joint 300 can be caused to rotate around the Z-axis. The inner ring 350, which is used for fixedly mounting the prism 30, is movably mounted on the outer ring 360 at a pivot 304 so that the inner ring 350 can be caused to rotate around the Y-axis. A first bending actuator 310 has a fixed end 312 and a movable end 314. The fixed end 312 is fixedly mounted on the imaging system (not shown) by a bracket 322. The movable end 314 of the bending actuator 310 is operatively connected to a bracket 324, which is linked to the outer ring 360. As such, the bending motion at the actuator end 314 can cause the outer ring 360 to rotate around the pivot 302 for yaw motion compensation. Similarly, a second bending actuator 330 has a fixed end 332 and a movable end 334. The fixed end 332 is fixedly mounted on the imaging system by a bracket 342. The movable end 334 of the bending actuator 330 is operatively connected to a bracket 344, which is linked to the inner ring 350. As such, the bending motion at the actuator end 334 can cause the inner ring 350 to rotate around the pivot 304 for pitch motion compensation.

It should be noted the bending actuator, according to the present invention, can be a piezoelectric monomorph actuator, a piezoelectric bimorph actuator, a piezoelectric multi-layer actuator, an ion conductive polymer actuator or the like. Furthermore, it is known in the art that an actuator needs a driving system for activating the actuator. FIG. 10 is a typical driving system. As shown, the actuator is operatively connected to a driving electronic module, which is connected to a camera movement sensor/signal processor so that the actuator moves the imaging component in response to the camera movement. The driving system is not part of the present invention. Moreover, the lens of the imaging system may comprise two or more lens elements and the actuators may be used to move one or more lens elements.

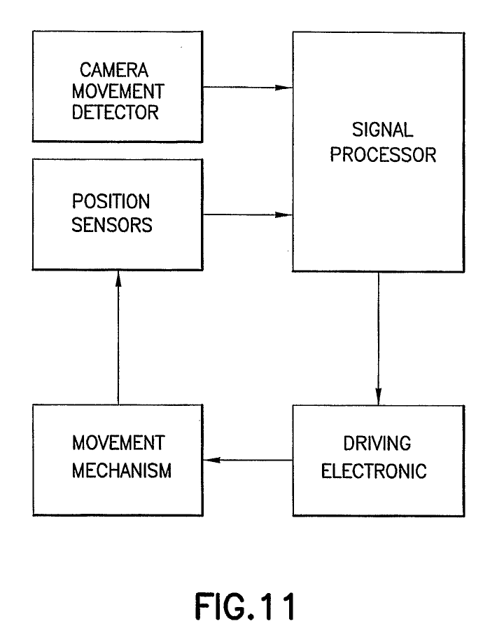

Furthermore, when the prism 30 is rotated along one or two axes for image stabilization purposes, other components are also needed. For example, the image stabilizer for the imaging system also has a movement detector to determine the movement to be compensated for, at least one position sensors to determine the current positions of the prism regarding the two rotational axes, a signal processor to compute the rotation amount in different directions for compensating for the camera movement based on the positions of the prism and the camera movement, and a control module is used to activate the movement mechanism order to rotate the prism by a desired amount. A block diagram illustrating such an image stabilizer is shown in FIG. 11. The movement detector may include a gyroscope or an accelerator, for example.

The lens of the imaging system may comprise two or more lens elements and the actuators may be used to move one or more lens elements.

It should be understood for a person skilled in the art that the prism that is used for folding the optical axis (or optical path) can be different from the prism 30 as shown in FIGS. 2 to 4. For example, the front face 32 (see FIG. 3) of the prism is not necessarily perpendicular to the base 36 and the angle between the back face 34 and the base 36 is not necessarily 45 degree. Furthermore, a different optical component that has one or more reflective surfaces can also be used as an optical folding device for folding the optical axis or optical path of an imaging system. The gimballed prism and joint, as depicted in FIGS. 7a to 9b are for illustration purposes only. The present invention in which two actuators are used to rotate an optical folding device, such as the prism, can also be achieved with a different gimbal design or arrangement.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. An imaging system, comprising:
an image forming medium located on an image plane;
a lens arranged to project an image on the image forming medium, the lens element defining an optical axis;
an optical path folding device disposed in relationship to the lens element for folding the optical axis into two sections; and
a movement mechanism operatively connected to the optical path folding device for moving the optical path folding device in order to shift the image on the image forming medium in response to an unwanted movement of the imaging system.

2. The imaging system of claim 1, wherein the image forming medium comprises an image sensor located substantially on an image plane of the imaging system.

3. The imaging system of claim 2, wherein the optical path folding device comprises a prism having a front face, a base face, and a back face joining the front face and the base face, and wherein the front face is substantially perpendicular to the image plane, the base face is substantially parallel to the image plane, and the back face is used for folding the optical axis via reflection.

4. The imaging system of claim 3, wherein the prism is rotatable about a first rotation axis substantially perpendicular to the image plane, and about a second rotation axis substantially parallel to the image plane and the back face of the prism.

5. The imaging system of claim 4, wherein the movement mechanism comprises a first movement device for rotating the prism around the first rotation axis and a second movement device for rotating the prism around the second rotation axis.

6. The imaging system of claim 5, wherein one or both of the first and second movement devices comprise an actuator.

7. The imaging system of claim 5, wherein one or both of the first and second movement devices comprise a motor.

8. An apparatus comprising:
a movement mechanism located in an imaging system, the imaging system comprising an image sensor located on an image plane, at least one lens element arranged to project an image on the image sensor, the lens element defining an optical axis, and
a reflection surface disposed in relationship to the lens element for folding the optical axis into two sections, wherein the movement mechanism is operatively connected to the reflection surface, for moving the reflection surface in order to shift the image on the image sensor in response to an unwanted movement of the imaging system.

9. The apparatus of claim 8, wherein the reflection surface is part of a prim, the prism having a front face, a base face, and a back face joining the front face and the base face, and wherein the front face is substantially perpendicular to the image plane, the base face is substantially parallel to the image plane, and the back face is used for folding the optical axis, and wherein the movement mechanism comprises:
a first movement device, operatively connected to the prism, for rotating the prism about a first rotation axis, the first rotation axis substantially perpendicular to the image plane, and
a second movement device, operatively connected to the prism, for rotating the prism about a second rotation axis, the second rotation axis substantially parallel to the image plane and the back face of the prism.

10. The apparatus of claim 9, wherein the first movement device comprises a first actuator, and the second movement device comprises a second actuator, said apparatus further comprising:
a driving mechanism for activating the first and second actuators based on the unwanted movement of the imaging system.

11. The apparatus of claim 10, wherein at least one of the first and second actuators comprises a bending actuator.

12. The apparatus of claim 10, wherein at least one of the first and second actuators comprises an on-axis actuator.

13. The apparatus of claim 9, wherein the first movement device comprises a motor, and the second movement device comprises a motor, said apparatus further comprising:
a driving mechanism for activating the motors in response to the unwanted movement of the imaging system.

14. The apparatus of claim 8, further comprising:
a driving mechanism arranged to activate the movement device in response to the unwanted movement of the imaging system;
a position sensor configured to sense a current position of the prism; and
a processor, operatively connected to the position sensor, for determining the moving amount of the prism based on the unwanted movement of the imaging system and a current position of the prism, so as to allow the movement mechanism to move the prism in order to compensate for the unwanted movement of the imaging system.

15. An image shifting method for use in an imaging system said method comprising
coupling a first movement device to a prism in the imaging system, the imaging system comprising
an image sensor located on an image plane of the imaging system; and
at least one lens element for projecting an image on the image sensor, the lens element defining an optical axis, wherein the prism is mounted in relationship to the lens element for folding the optical axis into two sections, wherein the prism has a front face, and a back face joining the front face and the base face, and wherein the front face is substantially perpendicular to the image plane, the base face is substantially parallel to the image plane, and the back face is used for folding the optical axis via reflection, the first movement device configured for rotating the prism about a first rotation axis, the first rotation axis substantially perpendicular to the image plane, and
coupling a second movement device to the prism, the second movement device configured for rotating the prism about a second rotation axis, the second rotation axis substantially parallel to the image plane and the back face of the prism so as to shift the projected image on the image sensor.

16. The shifting method of claim 15, wherein
one or both of the first movement device and
the second movement device are activated to effect the rotating of the prism in response to the unwanted movement of the imaging system.

17. An apparatus comprising:
movement means, located in an imaging system, the imaging system comprising an image sensor located on an image plane, at least one lens element arranged to project an image on the image sensor, the lens element defining an optical axis, and
means for reflection, disposed in relationship to the lens element for folding the optical axis into two sections, wherein said movement means is operatively connected to said means for reflection, for moving the reflection surface in order to shift the image on the image sensor in response to an unwanted movement of the imaging system.

18. The apparatus of claim 17, wherein said means for reflection is part of a prim, the prism having a front face, a base face, and a back face joining the front face and the base face, and wherein the front face is substantially perpendicular to the image plane, the base face is substantially parallel to the image plane, and the back face is used for folding the optical axis, and wherein the movement means comprises:
a first means, operatively connected to the prism, for rotating the prism about a first rotation axis, the first rotation axis substantially perpendicular to the image plane, and
a second means, operatively connected to the prism, for rotating the prism about a second rotation axis, the second rotation axis substantially parallel to the image plane and the back face of the prism.
